(19) United States
(12) Patent Application Publication
(10) Pub. No.: US 2002/0163684 A1
(43) Pub. Date: Nov. 7, 2002

(54) Optical noise reduction apparatus and method

(75) Inventors: Zhenguo Lu, Orleans (CA); Vincent So, Ottawa (CA)

Correspondence Address: SMART & BIGGAR, P.O. BOX 2999, STATION D, 55 METCALFE STREET, SUITE 900, OTTAWA, ON, K1P5Y6, CA

(73) Assignee: Ar Card

(21) Appl. No.: 09/819,760

(22) Filed: Mar. 29, 2001

Related U.S. Application Data
(60) Provisional application No. 60/254,856, filed on Dec. 13, 2000.

(51) Int. Cl. H04B 10/00

(52) U.S. Cl. 359/110; 359/161

(57) ABSTRACT

A noise reduction apparatus used to increase the signal-to-noise ratio (SNR) of an optical signal is provided. The structure of the noise reduction apparatus may be based on the Mach-Zehnder interferometer. To increase the SNR, the noise reduction apparatus makes use of the coherence of a coherent component of an optical signal having a coherent signal power and the incoherence of an incoherent component of the optical signal having an incoherent signal power. The optical signal is split in two path signals with each path signal having the same intensity but a different phase. The phase difference is tuned in a manner which produces a main output optical signal containing most of the coherent signal power and containing a fraction of the incoherent signal power, with the remaining incoherent signal power being diverted to one or more subsidiary outputs.

This application claims the benefit of US Provisional Patent Application Serial No. 60/254,856 filed Dec. 13, 2000.

### FIELD OF THE INVENTION

This invention relates generally to optical communications systems. More specifically, the invention relates to the signal-to-noise ratio of optical signals in communications systems, and to devices and methods for increasing the signal-to-noise ratio of such signals.

### BACKGROUND OF THE INVENTION

In optical systems the signal-to-noise ratio (SNR) of an optical signal tends to degrade as it propagates through optical media such as optical waveguides or optical fibers. The SNR of the optical signal may also degrade when the optical signal propagates through optical devices such as multiplexers. Opto-electronic regenerators can be used to improve the SNR of the optical signal but these devices are costly and inefficient. Erbium-doped fiber amplifiers (EDFAs) have been used to amplify weak optical signals without opto-electronic conversion. However, the amplification process adds noise causing SNR degradation. Noise performance in optical amplifiers is typically measured by the noise figure (NF) which is defined as the ratio of the SNR at the input of the optical amplifier to that at the output of the optical amplifier (NF=SNRᵢₙ/SNRₒᵤₜ). Under ideal conditions, a fiber amplifier may be fully inverted and the theoretical lower limit on the NF is 3 dB. This corresponds to the quantum limit of the NF. This quantum limit of the NF has limited the effectiveness of fiber amplifiers. Some optical amplifiers [R. A. Griffin, P. M. Lane, and J. J. O'Reilly, “Optical amplifier noise figure reduction for optical single-sideband signals,” Journal of Lightwave Technology, Vol.17, No.10, 1999, pp.1793-1796.] are used for NF reduction of optical single-sideband signals only and are not suited for other data-format signals and multi-channel optical signals. Other optical amplifiers [S. Lee, “Low-noise fiber-optic amplifier utilizing polarization adjustment,” U.S. Pat. No. 5,790,721, Aug. 4, 1998] [Y. C. Jung and C. H. Kim, “Optical Fiber Amplifer using Synchronized Etalon Filter”, U.S. Pat. No. 6,181,467, Jan. 30, 2000] [D. J. DiGivanni, J. D. Evankow, J. A. Nagel, R. G. Smart, J. W. Sulhoff, J. L. Zyskind, “High power, high gain, low noise, two-stage optical amplifier,” U.S. Pat. No. 5,430,572, Jul. 4, 1995.] have been developed to lower the NF but they are all constrained by the 3 dB quantum limit.

### SUMMARY OF THE INVENTION

A noise reduction apparatus is provided which increases the signal-to-noise ratio (SNR) of an input optical signal. To increase the SNR, the noise reduction apparatus makes use of the coherence of a coherent component of the input optical signal having a coherent signal power and the incoherence of an incoherent component of the input optical signal having an incoherent signal power. The input optical signal is split in two path signals with each path signal having the same intensity but a different phase. The phase difference is tuned in a manner which produces a main output optical signal containing most of the coherent signal power and containing a fraction of the incoherent signal power, with the remaining incoherent signal power being diverted to one or more subsidiary outputs.

One broad aspect of the invention provides a method of reducing incoherent signal power, in an input optical signal containing a coherent component having a coherent signal power and an incoherent component having the incoherent signal power. The method involves splitting the input optical signal into M path signals each having a respective coherent path component and a respective incoherent path component. A respective phase adjustment is applied to at least one, and preferably M−1 or M of the M path signals. The phase adjustments are applied such that at a combination point, the coherent path components are combinable constructively and each incoherent path component is substantially uncorrelated with each other incoherent path component. At the combination point, the M path signals are recombined to produce an output optical signal with an improved SNR.

In some embodiments, combining the M path signals to produce an output optical signal with an improved SNR involves coupling the M path signals together in a manner which produces the output optical signal containing most of the coherent signal power and containing a fraction of the incoherent signal power, with the remaining incoherent signal power being diverted to one or more secondary outputs.

The phase adjustments may be achieved using any suitable techniques. For example, the phase adjustments may be achieved by employing an optical path length difference, ΔLₒ, between any two consecutive signals of the M path signals which substantially satisfies ΔLₒ>L_{c} wherein L_{c} is the coherence length of the incoherent path components of the M path signals. It is noted that the optical path length difference, ΔLₒ, is a function of physical path length difference and/or index of refraction difference, when present. The optical path length difference, ΔLₒ, may result from using different physical path lengths and/or using paths made of optical transmission media having different indices of refraction. Fine phase adjustments to one or more of the path signals may be applied using phase controllers such as heaters, or piezoelectric devices to name a few examples.

To further improve the SNR, the splitting, the phase adjustment and the combining may be iterated N times wherein N satisfies N≧2. This method may result in an improvement of the SNR by a factor of approximately M^{N}.

The optical path length difference, ΔLₒ, may be chosen to satisfy a symbol spread tolerance. Preferably, the optical path length difference substantially satisfies ΔLₒ≦χC/R where C is the speed of light in vacuum; R is the symbol rate of the optical signals and χ is a fraction indicating a symbol spread to which the system is tolerant. For example, χ=0.2 indicates a 20% tolerance.

In some embodiments, the splitting, combining and phase adjustment may be performed with a Mach-Zehnder interferometer-based structure.

For multi-channel applications, the method may be applied to an optical signal having a plurality of equally spaced channels such that ΔLₒ=KC/(2 Δf) where, Δf=f′−f and, f′ and f are the frequencies of two consecutive channels of the input optical signal where K=1,2,3 . . . In this embodiment, preferably ΔLₒ is selected to satisfy the coherence length and symbol spread constraints through the appropriate selection of K.

Another broad aspect of the invention provides a noise reduction apparatus adapted to improve signal-to-noise ratio in an input optical signal having a coherent component and an incoherent component. The apparatus has an input optical splitter, two optical transmission media, and an output optical coupler. The input optical splitter might for example be a 1×2 single-mode optical coupler. The transmission media might be fibers or waveguides for example. The output optical coupler might for example be a 2×2 single-mode optical coupler. The input optical splitter is adapted to split the input optical signal into two path signals each having a respective coherent path component and a respective noise path component. Each one of the two path signals propagates through a respective one of the two optical transmission media. A phase controller is provided in at least one, and preferably both of the optical transmission media adapted to apply a phase adjustment to a respective one of the two path signals. The phase adjustment applied by the phase controller, and an optical path length difference, ΔLₒ, between the two optical transmission media are selected such that the noise path components are substantially uncorrelated with each other at the output optical coupler. The output optical coupler couples the path signals such that substantially all of the coherent signal is produced at a first output, while the noise component is substantially divided between the first output and a second output. In some embodiments, the NF may be further improved by including a further noise reduction apparatus within each one of the M paths. These further noise reduction apparatuses might be used to improve the SNR of a respective one of the M path signals before the path signals are recombined.

Another embodiment of the invention provides a noise reduction apparatus adapted to improve SNR in an input optical signal having a coherent component and an incoherent component. The noise reduction apparatus has an optical coupler, two optical transmission media, and two reflectors. The optical coupler might be a 2×2 single-mode coupler and the reflectors might be broadband fiber gratings or gold tip pig tail fiber reflectors. The optical coupler is adapted to split the input optical signal into two path signals each having a respective coherent path component and a respective incoherent path component, wherein each one of the two path signals propagates through a respective one of the two optical media to a respective one of the two reflectors where the respective path signal is reflected, and propagates back through the respective one of the two optical media to the optical coupler. There is at least one phase controller adapted to a respective phase adjustment to at least one of the two path signals wherein the respective phase adjustment is applied in a manner that at the optical coupler the coherent path components are coupled substantially into a single output of the optical coupler, and the incoherent component is coupled to multiple outputs.

Another broad aspect of the invention provides a method of designing a noise reduction apparatus. The method includes identification of a single frequency of interest, preferably a number of equally spaced frequencies. The method includes determining the minimum and maximum allowable values of an optical path length difference, ΔLₒ, between any two of M path signals such that incoherent path components of the any two of M path signals are substantially not correlated and satisfy a symbol spread tolerance, respectively.

In some embodiments, the method may include selecting a phase difference between any two of M path signals such that the optical path length difference, ΔLₒ, associated with the phase difference is greater than the minimum allowable value and smaller than the maximum allowable value. Preferably, the process of selecting a phase difference involves ΔLₒ satisfying ΔLₒ>L_{c} where L_{c} is the coherence length of the M path signals. Preferably, the process of selecting a phase difference involves ΔLₒ satisfying ΔLₒ≦χC/ω where C is the speed of light in vacuum, ω is the carrier data rate of an input optical signal and χ is a symbol spread tolerance. For single wavelength applications, the phase difference preferably satisfies δ=2pπ, where p=0,±1,±2, . . . . For multiple wavelength applications the phase difference preferably satisfies ΔLₒ=KC/(2 Δf) where Δf=f′−f and, f′ and f are the frequencies of two consecutive channels.

A broad aspect of the invention provides a noise reduction apparatus for improving the signal-to-noise ratio of an optical signal, having an input optical splitter adapted to split the optical signal into M path signals transmitted along respective M optical transmission paths, wherein M>=2. A phase adjustment device is provided in at least one of the M optical transmission paths adapted to apply a phase adjustment relative the M path signals. An output optical coupler is provided which is adapted to combine the M path signals into an output optical signal having a portion of incoherent components of each of the M path signals substantially uncorrelated and having coherent components of each M path signal constructively combined.

Another broad aspect of the invention provides a method of improving the signal-to-noise ratio of an optical signal which involves splitting the optical signal into a plurality of path signals, each path signal having a coherent path component and an incoherent path component, adjusting the phase of at least one of the plurality of path signals such that, at a combination point, the coherent path components are combinable constructively and each incoherent path component is substantially uncorrelated with each other incoherent path component; and combining the path signals at said combination point.

The invention according to yet another broad aspect provides a noise reduction apparatus for an optical signal having an optical splitter for splitting an input optical signal having a coherent signal component and an incoherent signal component into a plurality of path signals transmitted along a plurality of respective transmission paths, a phase adjustment device associated with at least one of the plurality of transmission paths for applying a phase difference between the plurality of path signals; and an optical coupler for combining the plurality of path signals into a main output optical signal and at least one subsidiary output optical signal, wherein the main output optical signal comprises substantially all of the coherent signal component and the subsidiary output signal comprises at least a portion of the incoherent signal component.

### BRIEF DESCRIPTION OF THE DRAWINGS

Preferred embodiments of the invention will now be described with reference to the attached drawings in which:

FIG. 1 is a block diagram illustrating a noise reduction apparatus, which is used to increase the signal to noise ratio (SNR), provided by a first embodiment of the invention;

FIG. 2 is a block diagram illustrating a noise reduction apparatus in which N noise reduction apparatuses of FIG. 1 are connected in series, provided by a second embodiment of the invention;

FIG. 3 is a block diagram illustrating a noise reduction apparatus, which is used to increase the SNR, provided by a third embodiment of the invention;

FIG. 4 is a block diagram illustrating a noise reduction apparatus, which is used to increase the signal to noise ratio (SNR), provided by a fourth embodiment of the invention; and

FIG. 5 is a flow chart of the method used to design the noise reduction apparatus of FIG. 1.

### DETAILED DESCRIPTION OF THE PREFERRED EMBODIMENTS

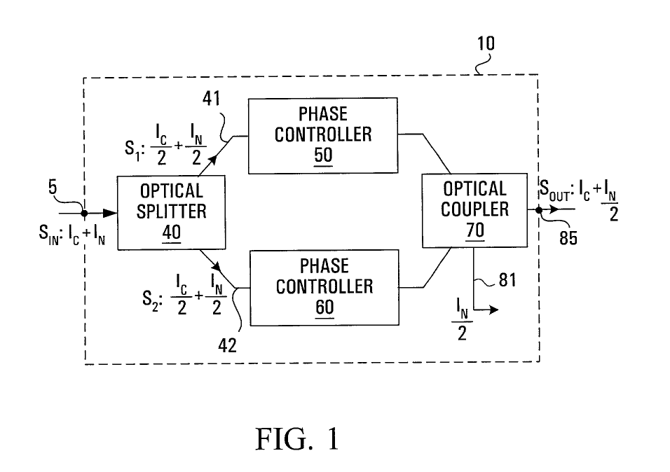

Referring to FIG. 1, shown is a schematic block diagram illustrating a noise reduction apparatus 10, which is suitable for both single and multi-channel optical systems. The noise reduction apparatus 10 has an input 5 connected to an input optical splitter 40 having one input and two outputs (for example, a 1×2 coupler). The two outputs of the input optical splitter 40 are connected to respective inputs of an output optical coupler 70 through first and second optical transmission media 41,42 respectively. The output optical coupler 70 has two inputs, a main output 85, and a subsidiary output, 81 (for example a 2×2 coupler). The optical transmission media 41 and 42 are equipped with respective phase controllers 50 and 60. The main output 85 of the output optical coupler 70 constitutes the output of the noise reduction apparatus 10. The subsidiary output 81 of the output optical coupler 70 is terminated locally.

The noise reduction apparatus 10 of FIG. 1 reduces noise by exploiting the coherence of an optical signal and the incoherence of the noise within the optical signal. In particular, according to the invention, an input optical signal S_{IN}, which includes a coherent component having intensity I_{C} and an incoherent component (the noise) having intensity I_{N}, is split by the input optical splitter 40 into two path signals S₁,S₂ that propagate along the optical transmission media 41,42 respectively. By “incoherent component” it is meant generally any unwanted component of the input signal Sᵢₙ which can be reduced in power by the apparatus 10, typically noise. Each path signal S₁,S₂ has a respective coherent path component having intensity I_{C}/2 and a respective incoherent (noise) path component having intensity I_{N}/2. The phase difference in the optical path lengths of the two optical transmission media 41,42, including the effects of the phase controllers 50,60 and including the effect of the input optical splitter 40, is selected such that path signal S₁ propagating in optical transmission medium 41 experiences a delay in time, Δt, compared with the path signal S₂ propagating in transmission medium 42. This delay in time is equivalent to a relative phase spread for coherent signals. According to the invention, this relative phase spread is chosen such that the coherent path component of the signal propagating through optical transmission medium 42 is almost completely coupled by output optical coupler 70 together with the coherent path component of the signal propagating through optical transmission medium 41 to the main output 85 in a manner that the two coherent path components interfere constructively and experience minimal loss. At the same time, the incoherent path components (the noise) of the two path signals S₁,S₂ become substantially uncorrelated with one another and couple equally into the main output 85 and the subsidiary output 81. The coherent signal power remains largely unaffected during the process of splitting and combining the two path signals with almost all of the coherent signal power being reproduced at the main output 85. On the other hand, the splitting and combining of the incoherent path component results in it being split approximately evenly between the main output 85 and the subsidiary output 81. This results in a much lower noise level and consequently results in a dramatic increase in the signal-to-noise ratio (SNR).

Theory of the Invention

At a combination point that exists at the output optical coupler 70, consider the case where there are two linearly polarized plane waves of the same wavelength, given by

\vec{E₁}(\vec{r}, t)=\vec{E₀₁}Cos[ωt−φ₁(\vec{r})−φ₀₁] (2)

\vec{E₂}(\vec{r},t)=\vec{E₀₂}Cos[ωt−φ₂(\vec{r})−φ₀₂] (3)

which have propagated along the optical transmission media 41,42 and overlap at the combination point. The resultant field is simply

\vec{E}(\vec{r},t)=\vec{E₁}(\vec{r},t)+\vec{E₂}(\vec{r},t) (4)

neglecting a constant factor, the irradiance can be expressed as the time average of the total field:

I=<[\vec{E₁}(\vec{r},t)+\vec{E₂}(\vec{r},t)]·[\vec{E₁}(\vec{r}, t)+\vec{E₂}(\vec{r},t)]>=I₁+I₂+I₁₂ (5)

where I₁=<\vec{E₁²}>, I₂=<\vec{E₂²}> and I₁₂₌₂<\vec{E₁}·\vec{E₂}>=2\sqrt{I₁I}Cosδ, the last term being known as the interference term and δ=φ₁(\vec{r})−φ₂(\vec{r})+φ₁₀−φ₂₀ being the phase difference in the plane waves at the combination point. The φ₁(\vec{r})−φ₂(\vec{r}) contribution to the phase difference is due to the above discussed relative phase spread experienced by the path signal S₁ compared to the path signal S₂. The φ₁₀−φ₂₀ contribution is due to an initial phase difference at the initial point introduced by input optical splitter 40. When φ₁₀−φ₂₀ is constant, the linearly polarized plane waves are said to be coherent. For coherent waves, the overall phase difference δ is expressible as δ=2πfΔt where Δt is the delay in time between the two optical transmission media 41,42 including the effects of the phase controllers 50,60 and the splitter 40. On the other hand, if the two waves are incoherent as is the case with incoherent path components in particular, they do not have a constant phase difference but rather have an “effective phase difference δ” which varies randomly and rapidly as compared to the measuring time (in other words, an incoherent signal is substantially uncorrelated with itself a constant time later). The term “effective phase difference” is used because it does not really make sense to refer to the phase of such incoherent components. The interference term I₁₂ is reduced to zero for such incoherent waves. Based on the above analysis, for coherent waves, when Cosδ=1, i.e. when δ=0,±2π,±4π, . . . , the irradiance I at the combination point has the maximum value Iₘₐₓ=I₁+I₂+2\sqrt{I₁I₂}. For incoherent waves, the irradiance I at the overlap point is always constant value I=I₁+I₂. For now, a simple rule will suffice: if the overlapping waves are coherent, their fields can combine with each other in a sustained fashion and will be added first and then squared to yield the irradiance. If the waves are incoherent, the individual fields, which are effectively independent, will be squared first and then these component irradiances added.

Another way of summarizing the behaviour is to look at the power transfer function of the apparatus of FIG. 1 which can be summarized as:

Main output=[cos²(δ/2)]input

Subsidiary output=[sin²(δ/2)]input

For a random phase difference δ such as is effectively the case for incoherent path components, the above can be time averaged and expressed as:

Main output=input/2

Subsidiary output=input/2

For a phase difference selected to satisfy, for the coherent path components, cos(δ/2)=±1, i.e., when δ=0,±2π,±4π, . . . , the transfer function can be time averaged and expressed as:

Main output=input

Subsidiary output=0.

The present invention can be used to reduce noise power by 3-dB. At the same time, the power of the coherent component of the input optical signal remains almost the same. Eventually, the signal-to-noise ratio of the input signal is increased by a factor of 2.

The individual components of FIG. 1 will now be described in further detail.

Input Optical Coupler

The function of the input optical splitter 40 is to split the input optical signal with intensity, I, at its input into two path signals having the same intensity, I/2, but varying by a phase difference, φ₁₀−φ₂₀ In a preferred embodiment of the invention, the input optical splitter 40 is a 1×2 3-dB single-mode fiber coupler, for example a fused-fiber coupler. In another embodiment of the invention, the input optical splitter 40 is a 2×2 3-dB single-mode fiber coupler. In embodiments of the invention in which the input optical splitter 40 is a 2×2 3-dB single-mode fiber coupler, the input optical signal is input at one of the two inputs of the 2×2 3-dB single-mode fiber coupler and the other input of the 2×2 3-dB single-mode fiber coupler is terminated. In other embodiments of the invention, the input optical splitter 40 is a micro-optical coupler or any type of optical device capable of producing the required function.

Optical Transmission Media

In the preferred embodiment of FIG. 1, the optical transmission media 41 and 42 are optical fibers. In another embodiment of FIG. 1, the optical transmission media 41 and 42 are waveguides. An optical signal that propagates through the optical transmission medium 41 undergoes a phase spread, φ₁(\vec{r}). Similarly, another optical signal that propagates through the transmission medium 42 undergoes a phase spread, φ₂(\vec{r}). The phase controllers 50 and 60 are used to fine tune the phase spreads φ₁(\vec{r}), φ₂(\vec{r}) respectively.

A phase difference, φ₁(\vec{r})−φ₂(\vec{r}) is introduced partially by the optical transmission media 41,42 per se and partially by the phase spreads introduced by the phase controllers 50,60. The component introduced by the optical transmission media 41,42 per se may be due to different physical lengths of the media and/or different indexes of refraction of the media. Recalling that the overall phase difference at the combination point (the output optical coupler 70) can be expressed as φ₁(\vec{r})−φ₂(\vec{r})+φ₁₀−φ₂₀, a coarse phase adjustment of the phase difference, φ₁(\vec{r})−φ₂(\vec{r})+φ₁₀−φ₂₀ can be achieved by first choosing different respective physical lengths of the optical transmission media 41 and 42 and/or by using lengths of optical transmission media having different respective nominal index of refraction. Fine adjustment of the overall phase difference φ₁(\vec{r})−φ₂(\vec{r})+φ₁₀−φ₂₀ is performed using the phase controllers 50,60.

Phase Controllers

The phase controllers 50,60 may be any devices capable of introducing in a controllable manner the required fine phase spread into the overall phase spread experienced by signals propagating in the optical transmission media 41,42. In one embodiment of the invention, the phase controllers 50 and 60 are heaters and the fine phase adjustment is done by changing the indexes of refraction of at least portions of the optical transmission media 41 and 42 by heating one or both of the optical transmission media 41 and 42.

In another embodiment, the phase controllers 50,60 are adapted to apply a stretching force to at least portions of one or both of the optical transmission media 41 and 42. This can be achieved for example through the use of piezo-electric devices.

In the embodiment of FIG. 1, the fine phase spread is implemented through a combination of the two phase controllers 50 and 60. In another embodiment, the fine phase spread is implemented through the use of only a single phase controller, for example phase controller 50 in which case phase controller 60 is not required. However, it is noted that the use of both phase controllers 50 and 60 allows the phase difference to be finely adjusted with more ease and accuracy.

In a preferred embodiment of the invention each one of the optical transmission media 41 and 42 has a constant nominal index of refraction throughout its length. Nominally, ΔLₒ=n₁L₁−n₂L₂ where L₁ and L₂ are the physical lengths of the optical transmission media 41 and 42, respectively, and n₁ and n₂ are the indices of refraction of the optical transmission media 41 and 42, respectively. In another embodiment of the invention the indices of refraction of the optical transmission media 41 and 42 vary over the length of their respective medium. Consequently, ΔLₒ=∫n₁(s₁)ds₁−∫n₂(s₂)ds₂. For example, each path may have a number of segments each having a length and each having an index of refraction in which case

$$Δ {L}_{o} = {\sum }_{i = 1}^{{N}_{1}} {}_{i}^{}{n}{}_{1}^{} {}_{i}^{}{L}{}_{1}^{} - {\sum }_{i = 2}^{{N}_{2}} {}_{i}^{}{n}{}_{2}^{} {}_{i}^{}{L}{}_{2}^{}$$

where one of the optical transmission media 41,42 is composed of N₁ segments with the i^{th} segment having indices of refraction and lengths {ᵢn₁,ᵢL₁}. Similarly, the other optical transmission medium of the optical transmission media 41,42 is composed of N₂ segments with the i^{th} segment having indices of refraction and lengths {ᵢn₂,ᵢL₂}. In this case, the fine phase control can be achieved through appropriate adjustment of any one or more of the indices of refraction ᵢn₁,ᵢn₂ and/or lengths ᵢL₁, ᵢL₂. Furthermore, the indices of refraction may vary continuously from one segment to another and/or within a segment in which case the above presented integral representation of ΔLₒ is a more accurate representation.

Any deviations in the optical path length difference ΔLₒ from p2π will result in some of the coherent signal power being output at subsidiary output 81 and lost.

Output Optical Coupler

The output optical coupler 70 is used as a combination point for combining two path signals each with intensity, I/2, but having a phase difference, δ, between the coherent path components at its two inputs. As indicated previously, the time-averaged intensity of the coherent path component of the output optical signal at the main output of the output optical coupler 70 is I<cos²(δ/2)>. Therefore, two coherent path signals at the first and second inputs of the output optical coupler 70 that have a constant phase difference, δ=±2pπ where p=0,±1,±2, . . . , are coupled entirely into the main output 85 of the output optical coupler 70 with intensity I, with no coherent signal strength being output at the subsidiary output 81. On the other hand, two independent incoherent optical signals have an effective phase difference, δ, which is a random function of time. In this case the two independent incoherent optical signals are coupled equally into the main output 85 and the subsidiary output 81, each with intensity I/2. In the preferred embodiment of FIG. 1, the output coupler 70 is a 2×2 3-dB single-mode fiber coupler with a 50:50 coupling ratio. More generally, any coupling device capable of combining the coherent components, and splitting off incoherent components to subsidiary outputs may be employed.

Design Constraints

The coherent and incoherent path components of the path signals that propagate through the transmission media 41,42 end up with a phase difference of φ₁(\vec{r})−φ₂(\vec{r})+φ₁₀−φ₂₀. The selection of this phase difference is made to ensure that the incoherent path components of the two path signals are not correlated at the point where recombination is to take place and to ensure that the coherent components combine constructively. The phase difference can be expressed as an optical path length difference, ΔLₒ.

A) Incoherence Length

Preferably, to ensure the incoherent path components are substantially uncorrelated, the optical path length difference, ΔLₒ, is selected to be greater than the coherence length, L_{c}, of the incoherent path components of the path signals (ΔLₒ>L_{c}). The choice ΔLₒ>L_{c} assures that the incoherent path components of the two path signals are independent and thus have a random phase difference between them and ensures that any incoherent path components are split approximately evenly between the main and subsidiary outputs of the output optical coupler. If ΔLₒ is less than L_{C}, then it is possible that some fraction less than 50% of the incoherent component will be directed to the subsidiary output. This will reduce the SNR improvement, but may still yield a workable design.

Constructive Combination

The optical path length difference, ΔLₒ, expressed as a phase difference is φ₁(\vec{r})−φ₂(\vec{r})+φ₁₀−φ₂₀. This quantity is selected such that the phase difference satisfies φ₁(\vec{r})−φ₂(\vec{r})+φ₁₀−φ₂₀=2pπ where p=0,±1,±2, . . . , for the wavelength(s) of interest with the result that the coherent path components are coupled into the output 85 and combined constructively. While there are many phase differences that satisfy 2pπ, p=±1, ±2, . . . , some of these are eliminated for failing to satisfy the coherence length constraint. Typically, the coherence length constraint requires the phase difference to satisfy 2pπ, where p is an integer with |p|>Pₘᵢₙ.

The intensity of the coherent component of the output signal is equal to the intensity of the coherent component of the input signal except for minor insertion losses in the input and output couplers 40 and 70, respectively, and the two phase controllers 50 and 60. On the other hand, the intensity of the incoherent component of the output optical signal is approximately one-half the intensity of the incoherent component of the input optical signal. Consequently, the SNR of the input optical signal is therefore increased by a factor of approximately 2.

B) Symbol Spread Tolerance

When the coherent components are split and then recombined, one of the coherent components is delayed with respect to the other. This results in a slight spreading of the symbols being carried by the recombined coherent component. The symbol rate applies another condition which limits the optical path length difference to ΔLₒ≦χC/R, where C is the speed of light in vacuum; R is the symbol rate of the optical signals and χ is a fraction indicating a maximum symbol spread to which the system is tolerant. For example, χ=0.2 indicates a 20% tolerance. This requirement is put in place to avoid the effects of smearing/dispersion which would result should the coherent components be so different in phase that a substantial symbol spread occurs.

Multi-channel Applications

For single wavelength applications, the case in which the SNR of the input optical signal is increased by a factor of approximately 2 requires that δ=2pπ where p=0,±1,±2, . . . ,. The method can also be used in multi-channel applications, in which case the input optical signal has a plurality of equally spaced (with respect to frequency) channels wherein any two consecutive channels with input wavelengths λ′ and λ differing by a spectral difference, Δλ=λ′−λ. To ensure the constructive recombination of all the wavelengths simultaneously at the combination point, the method requires that the optical path length difference, ΔLₒ, satisfies ΔLₒ=Kλλ′/2(Δλ)′where K=1, 2, 3, . . . . . Equivalently, this condition is satisfied by two consecutive channels of frequency f′ and f simultaneously when ΔLₒ=KC/(2Δf), where K=1,2,3, . . . , C is the speed of light in vacuum and Δf=f′−f. Therefore, the noise reduction apparatus 10 separates a number of periodically spaced channels of the input optical signal at its input 5 and outputs the respective channels at its output 85 with each channel having an increase in SNR by a factor of approximately 2. For example, a channel space of 100 GHz around λ=1550-nm with an optical path length difference of 1 mm, 2 mm, 3 mm, 4 mm or 5 mm is practical and satisfies OC192 networking systems. If the optical path length difference, ΔLₒ, is too long OC192 networking systems requirements are not satisfied. The optical path length difference, ΔLₒ, may also be chosen to be approximately equal to 1 mm or less to satisfy requirements of future OC768 networking systems.

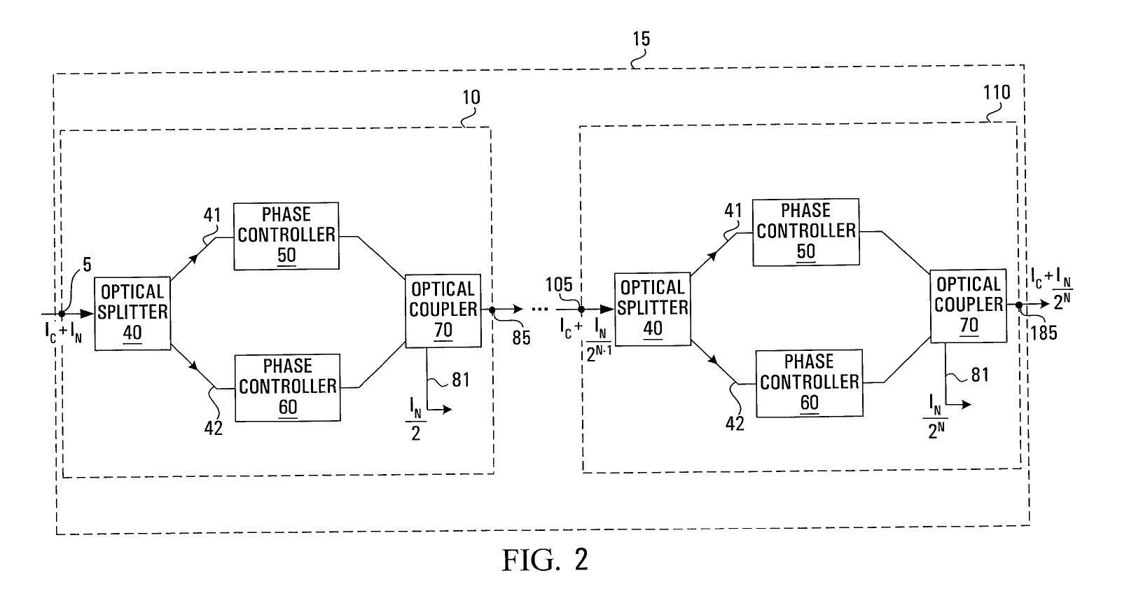

Referring to FIG. 2, shown is a noise reduction apparatus 15 provided by a second embodiment of the invention. The noise reduction apparatus 15 includes N noise reduction apparatuses 10,110(only two shown), which are each similar to the noise reduction apparatus 10 of FIG. 1. The N noise reduction apparatuses are connected in series such that an output of one of the N noise reduction apparatuses is connected to an input of a consecutive noise reduction apparatus of the N noise reduction apparatuses. A final noise reduction apparatus 110 of the N noise reduction apparatuses has an output 185 which corresponds to an output of the noise reduction apparatus 15.

An input optical signal is input at the input 5 and propagates through the N noise reduction apparatuses, two of which are the apparatuses 10 and 110, and is output at the output 185. The intensity of a coherent component of the input optical signal remains largely unaffected at the output 185. On the other hand, the intensity of a incoherent component of the input optical signal is decreased by a factor of approximately 2^{N} at the output 185. Consequently, the SNR of the input optical signal is increased by a factor of approximately 2^{N}, or 3N dB.

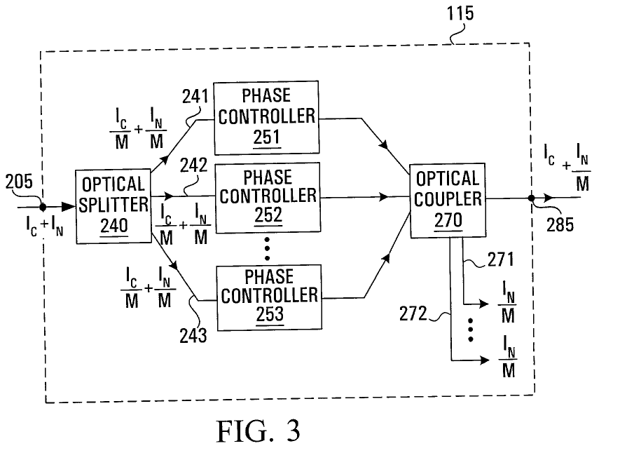

Referring to FIG. 3, shown is a noise reduction apparatus 115 provided by a third embodiment of the invention. The noise reduction apparatus 115 has an input 205 connected to an input optical splitter 240. In the preferred embodiment of FIG. 3, the input optical splitter 240 is a 1×M coupler and has one input and M outputs (only three shown) . In another embodiment of FIG. 3, the input optical splitter 240 is an M×M coupler and has M inputs and M outputs. There are M optical transmission media (only three shown), three of which are optical transmission media 241, 242 and 243. Each one of the M optical transmission media is connected between one of the M outputs of the input optical splitter 240 and one of M inputs (only three shown) of an output coupler 270. The optical lengths of the M optical transmission media are chosen such that the optical path length difference, ΔLₒ, between any two of the M optical transmission media is greater than the coherence length, L_{c}, of incoherent path components of M path signals propagating through the respective M optical transmission media. Each one of the M transmission media passes through a phase controller (only three shown). The optical transmission media 241, 242 and 243 pass through phase controllers 251, 252 and 253, respectively. The output optical coupler 270 is a M×M coupler that has M outputs (only three shown) one of which is the main output 285 of the noise reduction apparatus 115. The remaining M−1 outputs 271, 272 are subsidiary outputs terminated locally (only two shown). The outputs 271 and 272 are terminated locally.

In the preferred embodiment of FIG. 3, each one of the M optical transmission media passes through a respective one of the M phase controllers. In another embodiment of FIG. 3, there are M−1 phase controllers and all but one of the M optical transmission media passes through a respective one of the M−1 phase controllers. Preferably, there is at least one phase controller.

In the preferred embodiment of FIG. 3, an input optical signal is input at the input 205. The input optical signal has a coherent component and an incoherent component (noise) with intensities, I_{C} and I_{N}, respectively. The input optical splitter 240 splits the input optical signal into M path signals. Each one of the M path signals has a coherent and incoherent path component. The coherent path components of the path signals have the same intensity, I_{C}/M, but vary in phase with a phase difference, φᵢ₀−φⱼ₀ where i,j=1,2, . . . ,M, between any two path signals of the M paths. Similarly, the incoherent path components of the two path signals have the same intensity, I_{N}/M. The coherent and incoherent path components of each of the path signals propagate through a respective one of the M optical transmission media and undergo a phase spread, φᵢ(\vec{r}) (i=1 to M). For example, the coherent and incoherent components of three path signals propagate through a respective one of the optical transmission media 241, 242 and 243 and undergo phase spreads, φ₁I(\vec{r}), φ₂(\vec{r}) and φ₃(\vec{r}), respectively. The M phase controllers perform a fine phase adjustment of a phase φᵢ(\vec{r}) (i=1 to M) such that a phase difference, δ=φᵢ(\vec{r})−φⱼ(\vec{r})+φᵢ₀−φⱼ₀ (i, j=1 to M), between any two of the coherent path components of the M path signals satisfies δ=2pπ where p=0,±1,±2, . . . . After propagating through the M phase controllers the respective path signal then propagates to a respective input of the M inputs of the output optical coupler 270. At the output optical coupler 270 the coherent path components of the M path signals are combined constructively such that the intensity of a coherent component of an output optical signal at the output 285 is approximately equal to I_{C}. In addition, at the output optical coupler 270 the incoherent path components of the M path signals are coupled equally into the M outputs such that the intensity of the incoherent component of the output optical signal at the output 285 is approximately equal to I_{N}/M.

The intensity of the coherent component of the output optical signal is equal to the intensity of the coherent component of the input optical signal except for minor losses in the input optical splitter 240 and the coupler 270, respectively, the optical transmission media 41,42 and the M phase controllers. On the other hand, the intensity of the incoherent component of the output signal is reduced by a factor of approximately M of the intensity of the incoherent component of the input optical signal. Consequently, the SNR of the input optical signal is therefore increased by a factor of approximately M.

In another embodiment of FIG. 3, N noise reduction apparatuses similar to the noise reduction apparatus 115 are connected in series such that an output of one of the N noise reduction apparatuses is connected to an input of a consecutive noise reduction apparatuses of the N noise reduction apparatuses. In this embodiment, the SNR ratio of an input optical signal propagating through the N noise reduction apparatuses is increased by a factor of approximately M^{N} resulting in an increase in SNR of approximately 10N(logM)dB.

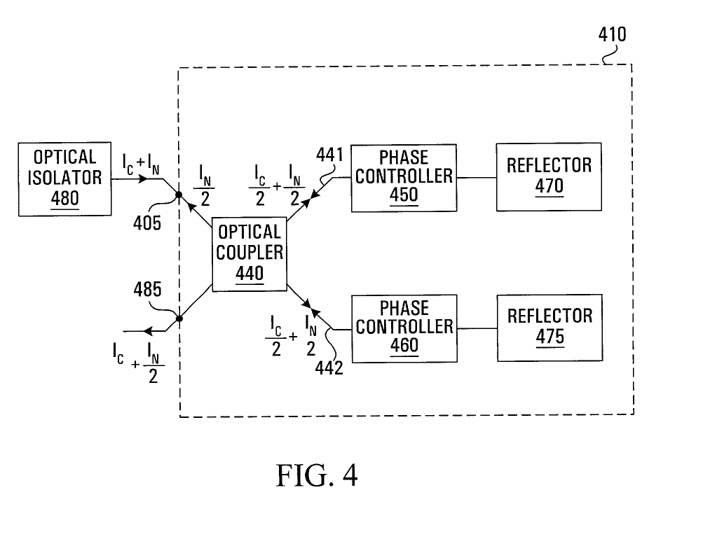

Referring to FIG. 4, shown is a noise reduction apparatus 410 provided by a fourth embodiment of the invention. The noise reduction apparatus 410 has an input 405 and an output 485. The input 405 and the output 485 are connected to a coupler 440. Optical transmission media 441 and 442 are connected to the coupler 440. The optical transmission media 441 and 442 are also connected to reflectors 470 and 475, respectively. In addition, the optical transmission media 441 and 442 pass through phase controllers 450 and 460. An optional optical isolator 480 is connected to the input 405 of the noise reduction apparatus 410.

In the preferred embodiment of FIG. 4, the coupler 440 is a 2×2 3-dB single-mode fiber coupler and the reflectors 470 and 475 are broadband fiber gratings. In another embodiment, the coupler 440 is a 2×2 single-mode micro-optics coupler and the reflectors 470 and 475 are different types of reflectors such as gold tip pig tail fiber reflectors.

In a preferred embodiment of the invention of FIG. 4, an input optical signal is input at the input 405. The input optical signal has a coherent component and an incoherent component with intensities, I_{C} and I_{N}, respectively. The coupler 440 splits the input optical signal into two path signals with each path signal having a coherent path component and incoherent path component with intensities, I_{C}/2 and I_{N}/2, respectively. The coherent path components of the two path signals have a phase difference, φ₁₀−φ₂₀, which is a constant whereas the incoherent path components of the two path signals have a phase difference, φ₁₀−φ₂₀, which is a random function of time. Each one of the two path signals performs a round trip propagating through its respective phase controller of the phase controllers 450 and 460 to its respective reflector of the reflectors 470 and 475 where it is reflected; and back through its respective phase controller of the phase controllers 450 and 460 to the coupler 440. A path signal of the two path signals that performs a round trip by passing through the phase controller 450 undergoes a phase adjustment, φ₁(\vec{r}) and a path signal of the two path signals that performs a round trip by passing through the phase controllers 460 undergoes a phase adjustment, φ₂(\vec{r}), resulting in a phase difference, φ₁(\vec{r})−φ₂(\vec{r}). An optical path length difference, ΔLₒ, associated with the phase difference, φ₁(\vec{r})−φ₂(\vec{r}), is selected to be greater than the coherence length, L_{c}, of the incoherent components of the path signals. After a round trip the two path signals each have coherent path components with intensity, I_{C}/2, and incoherent path components with intensity, I_{N}/2 at the coupler 440. At the coupler 440 the coherent path components of the two path signals have a phase difference, δ=φ₁(\vec{r})−φ₂(\vec{r})+φ₁₀−φ₂₀=2pπ where p=0,±1,±2, . . . , whereas the effective phase difference, δ, between the incoherent path components of the two path signals, is a random function of time. The coupler 440 combines the two path signals into output optical signals that are output at output 485 and input 405.

The intensities of the coherent and incoherent path components of the output signal at output 485 are given by I_{C}<Cos²(δ/2)> and I_{N}/2, respectively, and intensities of the coherent and incoherent path components of the output signal at input 405 are given by I_{C}<sin²(δ/2)> and I_{N}/2. The phase controllers 450 and 460 perform a fine phase adjustment such that δ=2pπ where p=0,±1,±2, . . . , at the coupler 440. Therefore, with proper tuning δ, at output 485, the coherent path components of the two path signals combine constructively with intensity, I_{C} at output 485 and input 405. Since the optical path length, ΔLₒ, is greater than the coherence length of the incoherent path components of the two path signals, they couple with intensity, I_{N}/2, into output 485 and input 405. Consequently, the SNR of the input optical signal at the input 405 is increased by a factor of approximately 2 at the output 485. The optional optical isolator 480 suppresses the output optical signal at the input 405.

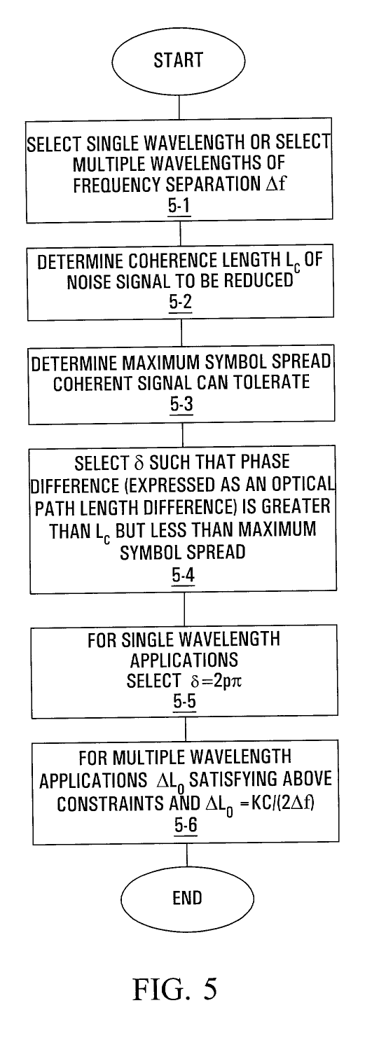

Referring to FIG. 5, shown is a flow chart of a preferred method of selecting a phase difference for use in the apparatus of FIG. 1. The method starts with the identification of a single wavelength of interest λ, or the identification of a set of wavelengths of interest having constant frequency spacing Δf between any two consecutive wavelengths (step 5-1). In the following steps the coherence length, L_{c}, of the M path signals is determined (step 5-2) and the maximum symbol spread the coherent path components can tolerate (step 5-3). An optical path length difference between any two coherent path components is selected by choosing a phase difference such that an optical path length difference, ΔLₒ, satisfies the following criteria: 1) ΔLₒ>L_{c} where L_{c} is a coherence length of the incoherent path components of the M path signals (step 5-4); 2) ΔLₒ selected for satisfactory symbol spread (step 5-4); 3) For single wavelength applications, a phase difference is selected associated with any two paths of the M path signals, resulting in a phase difference, δ=2pπ where p=0,±1,±2, . . . , between the coherent components of any two of the M path signals at a combination point (step 5-5); 4) For multiple wavelength applications, ΔLₒ=KC/(2Δf) (step 5-6) where, Δf=f′−f and, f′ and f are the frequencies of two consecutive channels of the input optical signal. For single wavelength applications, the simultaneous satisfaction of all the constraints involves the proper selection of p. To satisfy these three constraints simultaneously for multiple wavelength applications involves the proper selection of K.

In a preferred embodiment M=2 and N=1 resulting in an increase in the SNR of the input optical signal of approximately 2 and an increase in the SNR of approximately 3 dB.

In yet another way of implementing this invention, the noise reduction apparatus can be implemented with M paths, and within each of the M paths, a further noise reduction apparatus having Nᵢ paths may be provided to improve the SNR of a respective one of the M path signals.

In some implementations, the noise reduction apparatuses described above are further equipped with a power detector connected to at least one subsidiary output of the noise reduction apparatus and to a control device. The power detector converts the subsidiary optical signal into a signal representative of the power of the subsidiary optical signal. The control device is adapted to control at least one of the phase adjustments applied to the path signals as a function of the output of the power detector. Assuming that the phase adjustments result in the required characteristic of uncorrelated incoherent components, this control function minimizes the power in the subsidiary optical signal which in turn minimizes the coherent power in the subsidiary optical signal, which in turn maximizes the coherent power in the main output.

Numerous modifications and variations of the present invention are possible in light of the above teachings. It is therefore to be understood that within the scope of the appended claims, the invention may be practised otherwise than as specifically described herein.

We claim:

1. A method of reducing incoherent signal power in an input optical signal containing a coherent component having a coherent signal power and a incoherent component having the incoherent signal power, the method comprising:
splitting the input optical signal into M path signals each having a respective coherent path component and a respective incoherent path component and wherein M satisfies M≧2;
applying a respective phase adjustment to each of the M path signals, the phase adjustments comprising at least one fine phase adjustment applied to at least one of the M path signals, wherein the phase adjustment are applied such that at a combination point, the coherent path components are combinable constructively and each incoherent path component is substantially uncorrelated with each other incoherent path component;
at the combination point, combining the M path signals to produce an output optical signal with an improved signal-to-noise ratio.

2. A method according to claim 1 wherein combining the M path signals to produce an output optical signal with an improved signal-to-noise ratio comprises coupling the M path signals together in a manner which produces the output optical signal containing most of the coherent signal power and containing a fraction of the incoherent signal power, with the remaining incoherent signal power being diverted to one or more subsidiary outputs.

3. A method according to claim 2 wherein the phase adjustments are achieved by employing an appropriately selected optical path length difference, ΔLₒ, between any two consecutive path signals of the M path signals.

4. A method according to claim 3 wherein the optical path length difference, ΔLₒ, between any two consecutive path signals of the M path signals substantially satisfies ΔLₒ>L_{c}, where L_{c} is the coherence length of the incoherent path components of the M path signals.

5. A method according to claim 3 wherein the optical path length difference, ΔLₒ between any two consecutive path signals of the M path signals substantially satisfies ΔLₒ≦χC/R wherein C is the speed of light in vacuum, R is a symbol rate of the input optical signal and χ is a symbol spread tolerance.

6. A method according to claim 1 adapted for single wavelength application, wherein the optical path length difference ΔLₒ, between any two path signals of the M path signals results in a corresponding phase difference substantially satisfying δ=2pπ, where p=±1,±2, . . . for a wavelength of interest.

7. A method according to claim 6 wherein a particular value of p is selected such that the corresponding optical path length difference, ΔLₒ, between any two consecutive path signals of the M path signals substantially satisfies ΔLₒ>L_{c} wherein L_{c} is the coherence length of the incoherent path components of the M path signals, and substantially satisfies ΔLₒ≦χC/R wherein C is the speed of light in vacuum, R is a symbol rate of the input optical signal and χ is a symbol spread tolerance.

8. A method according to claim 1 adapted for multiple wavelength application with the input optical signal comprising a plurality of equally spaced channels with any two consecutive channels differing in frequency by, Δf=f′−f , wherein the optical path length difference, ΔLₒ, substantially satisfies ΔLₒ=KC/2Δf, wherein K=1,2,3, . . . , and C is the speed of light in vacuum.

9. A method according to claim 8 wherein a particular value of K is selected such that the optical path length difference, ΔLₒ, between any two path signals of the M path signals substantially satisfies ΔLₒ>L_{c}, where L_{c} is the coherence length of the incoherent path components of the M path signals, and substantially satisfies ΔLₒ≦χC/R wherein C is the speed of light in vacuum, R is a symbol rate of the input optical signal and χ is a symbol spread tolerance.

10. A method according to claim 1 wherein M=2.

11. A method according to claim 1 wherein the splitting, the phase adjustment and the combining are performed N times wherein N satisfies N≧2.

12. A method according to claim 11 wherein the SNR is improved by a factor of M^{N}.

13. A method according to claim 1 wherein applying the respective phase adjustments comprises passing each of the path components through a respective transmission medium having a different respective optical path length.

14. A method according to claim 13 wherein the applying a fine phase adjustment to at least one path signal comprises applying a respective fine phase adjustment to at least M−1 of the M path signals.

15. A method according to claim 13 wherein the applying a respective phase adjustment to at least one path signal further comprises applying a respective fine phase adjustment each of the M path signals.

16. A method according to claim 2 further comprising measuring a power of at least one subsidiary output, and tuning at least one of the phase adjustments to minimize the power of the subsidiary output.

17. A method according to claim 1 wherein the splitting, combining and phase adjustment are performed with a Mach-Zehnder interferometer-based structure.

18. A method according to claim 1 wherein the splitting, combining and phase adjustment are performed with a Michelson interferometer-based structure.

19. A noise reduction apparatus adapted to improve signal-to-noise ratio in an input optical signal containing a coherent component having a coherent signal power and an incoherent component having an incoherent signal power, the apparatus comprising:
an input optical splitter, M optical transmission paths, and an output optical coupler, where M>=2;
wherein the input optical splitter is adapted to split the input optical signal into M path signals each having a respective coherent path component and a respective incoherent path component, wherein each one of the M path signals propagates through a respective one of the M optical transmission paths resulting in a respective phase adjustment to the respective path signal; and
a fine phase adjustment device in at least one of the optical transmission paths adapted to apply a fine phase adjustment to a respective one of the M path signals;
wherein the phase adjustment applied by the transmission media in combination with the fine phase adjustment applied by the at least one fine phase adjustment device results in an optical path length difference, ΔLₒ, between the two optical transmission media selected such that the incoherent path components are substantially not correlated with each other at the output optical coupler;
wherein the output optical coupler couples the path signals such that substantially all of the coherent signal power is produced at a main output, while the incoherent signal power is substantially divided between the main output and one or more subsidiary outputs.

20. A noise reduction apparatus according to claim 19 wherein each of the M optical transmission paths comprises a respective plurality of segments of optical transmission media with each segment having length and a respective index of refraction; wherein the fine phase adjustment device comprises means for adjusting at least one of the lengths and/or indices of refraction.

21. A noise reduction apparatus according to claim 20 wherein a phase adjustment device is provided in each optical transmission.

22. A noise reduction apparatus according to claim 19 wherein the optical transmission paths are optical waveguides.

23. A noise reduction apparatus according to claim 19 wherein the optical transmission paths are optical fibers.

24. A noise reduction apparatus according to claim 19 wherein M=2 and the input optical splitter is a 1×2 3-dB single-mode coupler.

25. A noise reduction apparatus according to claim 19 wherein M=2 and the input optical splitter is a 2×2 3-dB single-mode coupler.

26. A noise reduction apparatus according to claim 19 wherein M=2 and the output optical coupler is a 2×2 3-dB single-mode coupler.

27. A noise reduction apparatus according to claim 19 wherein said at least one fine phase adjustment device comprises a fine phase adjustment device in each of the M optical transmission media adapted to apply a respective phase adjustment to each of the M path signals.

28. A noise reduction apparatus according to claim 19 wherein the fine phase adjustment device comprises at least one heater adapted to introduce the fine phase adjustment by varying an index of refraction in at least part of the optical transmission path through the application of heat.

29. A noise reduction apparatus according to claim 19 wherein the at least one fine phase adjustment device comprises at least one device adapted to introduce a phase adjustment by applying a stretching force to at least part of one of the optical transmission path to change the physical length of the optical transmission path.

30. A noise reduction apparatus according to claim 29 wherein the at least one device is a piezo-electric device.

31. A noise reduction apparatus comprising a plurality of noise reduction apparatuses of claim 19 arranged in a serial configuration.

32. A noise reduction apparatus according to claim 31 further comprising a further noise reduction apparatus within at least one of the paths.

33. A noise reduction apparatus adapted to improve SNR in an input optical signal having a coherent component and an incoherent component, the apparatus comprising:
an optical coupler, two optical transmission media, and two optical reflectors;
wherein the optical coupler is adapted to split the input optical signal into two path signals each having a respective coherent path component and a respective incoherent path component, wherein each one of the two path signals propagates through a respective one of the two optical media to a respective one of the two optical reflectors where the respective path signal is reflected, and propagates back through the respective one of the two optical media to the optical coupler; and
at least one fine phase adjustment device adapted to apply a respective phase adjustment to at least one of the two path signals wherein the respective phase adjustment is applied in a manner that at the optical coupler the coherent path components are coupled substantially into a single output of the coupler, and the incoherent component is coupled to multiple outputs.

34. A noise reduction apparatus according to claim 33 wherein the SNR of the input signal is increased by a factor of 2.

35. A noise reduction apparatus according to claim 34 wherein the two reflectors are broadband fiber gratings.

36. A noise reduction apparatus according to claim 34 wherein the two reflectors are gold tip pig tail fiber reflectors.

37. A noise reduction apparatus according to claim 34 wherein the coupler is a 2×2 single-mode coupler.

38. A method of designing a noise reduction apparatus comprising:
determining a minimum allowable value of an optical path length difference, ΔLₒ, between any two of M path signals such that incoherent path components of the any two of M path signals are substantially not correlated;
determining a maximum allowable value of the optical path length difference, ΔLₒ, between any two of M path signals to satisfy a symbol spread tolerance;
selecting a phase difference between any two of M path signals in a manner that the optical path length difference, ΔLₒ, associated with the phase difference is greater than the minimum allowable value and smaller than the maximum allowable value, and in a manner that the coherent path components of the M path signals are combined constructively at a combination point.

39. A method according to claim 38 wherein determining the minimum allowable value of the optical path length difference, ΔLₒ, determining L_{c}, a coherence length of the incoherent path components of the M path signals.

40. A method according to claim 39 wherein determining the maximum allowable value of the optical path length difference, ΔLₒ, comprises determining ΔLₒ satisfying ΔLₒ≦χC/R where C is the speed of light in vacuum, R is the symbol rate of an input optical signal and χ is a symbol spread tolerance.

41. A method according to claim 40 wherein the phase difference substantially satisfies δ=2pπ, where p=±1,±2, . . . for a wavelength of interest, a particular value of p being selected such that the optical path length difference satisfies the minimum and maximum allowable values.

42. A method according to claim 40 further comprising:
identifying a set of frequencies having a frequency difference, Δf;
selecting the optical path length difference, ΔLₒ, between any two of the M path signals which satisfies ΔLₒ=KC/(2Δf) where C is the speed of light in vacuum and K=1,2,3, . . . , the particular value of K being selected such that the optical path length satisfies the minimum and maximum allowable values.

43. A noise reduction apparatus according to claim 18 further comprising a power detector connected to at least one subsidiary output of the noise reduction apparatus and to the controlling device, the power detector adapted to convert a subsidiary optical signal into a signal representative of the power of the subsidiary optical signal.

44. A noise reduction apparatus according to claim 43 wherein the controlling device is adapted to control at least one of the phase adjustments applied to the path signals as a function of the output of the power detector.

45. A noise reduction apparatus for improving the signal-to-noise ratio of an optical signal, comprising:
an input optical splitter adapted to split the optical signal into M path signals transmitted along respective M optical transmission paths, wherein M>=2;
a phase adjustment device in at least one of the M optical transmission paths adapted to apply a phase adjustment relative the M path signals; and
an output optical coupler adapted to combine the M path signals into an output optical signal having a portion of incoherent components of each of the M path signals substantially uncorrelated and having coherent components of each M path signal constructively combined.

46. A method of improving the signal-to-noise ratio of an optical signal comprising:
splitting the optical signal into a plurality of path signals, each path signal having a coherent path component and an incoherent path component;
adjusting the phase of at least one of the plurality of path signals such that, at a combination point, the coherent path components are combinable constructively and each incoherent path component is substantially uncorrelated with each other incoherent path component; and
combining the path signals at said combination point.

47. A noise reduction apparatus for an optical signal comprising:
an optical splitter for splitting an input optical signal having a coherent signal component and an incoherent signal component into a plurality of path signals transmitted along a plurality of respective transmission paths;
a phase adjustment device associated with at least one of the plurality of transmission paths for applying a phase difference between the plurality of path signals; and
an optical coupler for combining the plurality of path signals into a main output optical signal and at least one subsidiary output optical signal, wherein the main output optical signal comprises substantially all of the coherent signal component and the subsidiary output signal comprises at least a portion of the incoherent signal component.
